(19) United States
(12) Patent Application Publication
(10) Pub. No.: US 2025/0138399 A1
(43) Pub. Date: May 1, 2025

(54) TRIPOD MOUNT, TRIPOD MOUNT UNIT, AND OPTICAL APPARATUS

(71) Applicant: CANON KABUSHIKI KAISHA, Tokyo (JP)

(72) Inventor: HYOCHORU TANAKA, Tochigi (JP)

(21) Appl. No.: 18/910,180

(22) Filed: Oct. 9, 2024

(30) Foreign Application Priority Data
Oct. 26, 2023 (JP) 2023-183630

(51) Int. Cl. G03B 17/56; F16M 11/04; F16M 11/24

(52) U.S. Cl. CPC G03B 17/561; F16M 11/041; F16M 11/242

(57) ABSTRACT

A tripod mount attachable to and detachable from a tripod mount base fixable to a lens barrel, the tripod mount comprising: a tripod mount main body that abuts on a tripod mount base and has a slit, a tripod mount lock knob screwed to the tripod mount main body and capable of fixing the tripod mount to the tripod mount base by deforming the tripod mount main body so as to change a width of the slit, and a tripod mount temporary lock release button fitted to the tripod mount main body and capable of temporarily fixing the tripod mount to the tripod mount base, wherein the tripod mount lock knob and the tripod mount temporary lock release button are disposed so as to advance and retract in a direction intersecting the slit.

### BACKGROUND

### Technical Field

The present disclosure relates to a tripod mount, a tripod mount unit, and an optical apparatus.

### Description of the Related Art

When a tripod or a monopod is fastened to the tripod mount of the lens barrel, the center of gravity of the camera system can be balanced. Therefore, more stable photographing can be performed than in the case where the camera is used on a tripod. On the other hand, when the tripod mount is attached to the lens barrel, the mass of the lens barrel increases, and the mobility may be reduced. Therefore, a detachable tripod mount which can be detached at the time of hand-held photographing has been proposed.

Japanese Patent Application Laid-Open No. 2003-337275 discloses a configuration of a tripod mount including a lock plate as a falling-off prevention member. A projection portion of the lock plate enters and engages with a hole portion provided in a ring member to lock the lens barrel body so that the lens barrel body does not inadvertently come off from the base portion.

### SUMMARY

An object of some embodiments disclosure is to provide a tripod mount in which a falling-off prevention mechanism is not inadvertently released when a lens barrel is carried with the tripod mount.

According to some embodiments of the present invention, a tripod mount attachable to and detachable from a base member fixable to an optical apparatus, the tripod mount comprising: a main body portion that abuts on the base member and has a slit portion, a first operation member screwed to the main body portion and capable of fixing the tripod mount to the base member by deforming the main body portion so as to change a width of the slit portion, and a second operation member fitted to the main body portion and capable of temporarily fixing the tripod mount to the base member, wherein the first operation member and the second operation member are disposed so as to advance and retract in a direction intersecting the slit portion.

Further features of the present disclosure will become apparent from the following description of exemplary embodiments with reference to the attached drawings.

### BRIEF DESCRIPTION OF THE DRAWINGS

FIG. 1 is a view illustrating a state where the tripod mount (20) according to the embodiment is attached to a lens barrel (100).

FIG. 2 is a view illustrating the tripod mount unit (200) according to the embodiment.

FIG. 3 is a perspective view illustrating attachment of the tripod mount (20) to the tripod mount base (13).

FIG. 4 is an exploded perspective view of the tripod mount (20).

FIG. 5 is a side view of the tripod mount (20).

FIG. 6 is a plan view of the tripod mount (20).

FIG. 7 is a bottom view of the tripod mount (20).

FIG. 8 is a cross-sectional view taken along line VIII-VIII in FIG. 5.

FIG. 9 is a cross-sectional view taken along line IX-IX of FIG. 5.

FIG. 10 is a cross-sectional view taken along line X-X of FIG. 2.

FIG. 11 is a cross-sectional view taken along line XI-XI of FIG. 5 when the temporary lock is released.

FIG. 12 is a cross-sectional view taken along line XII-XII in FIG. 2 when the temporary lock is released.

FIG. 13 is a cross-sectional view taken along line XIII-XIII of FIG. 5 with exaggerated deformation by the tripod mount lock knob (22).

FIG. 14 is an enlarged view of a range D in FIG. 13.

FIG. 15 is an enlarged view of a range E in FIG. 13.

### DESCRIPTION OF THE EMBODIMENTS

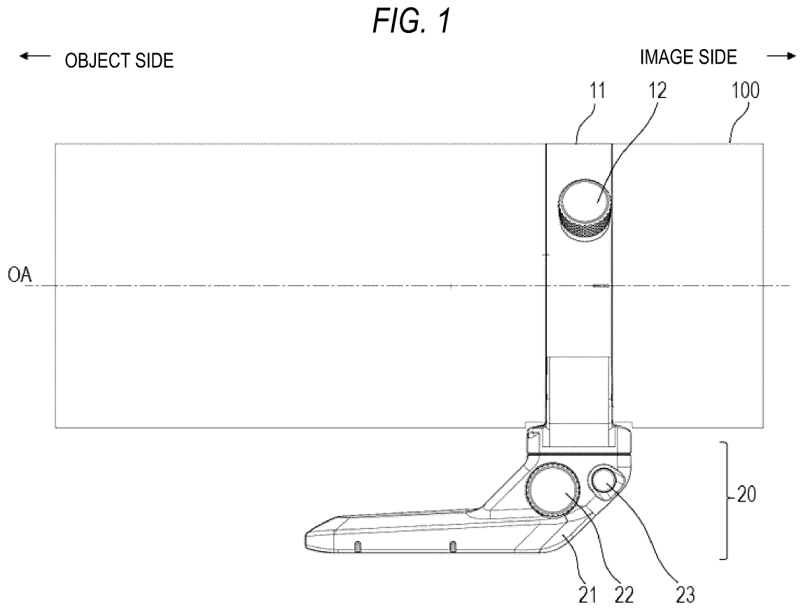

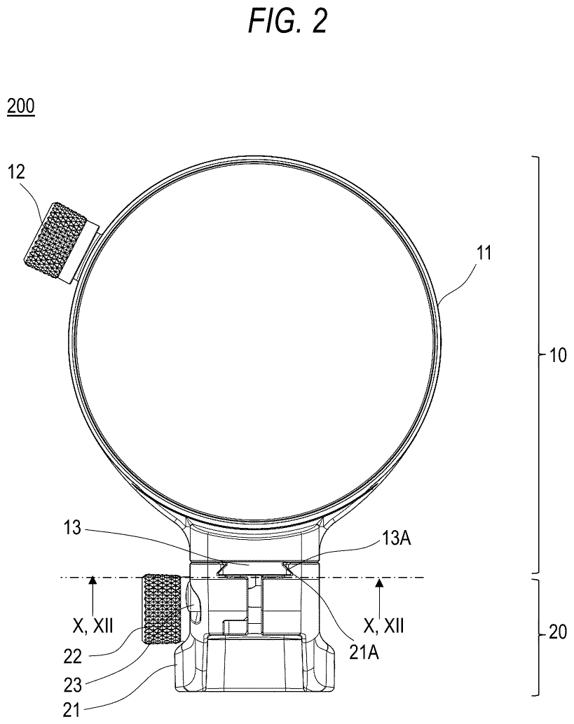

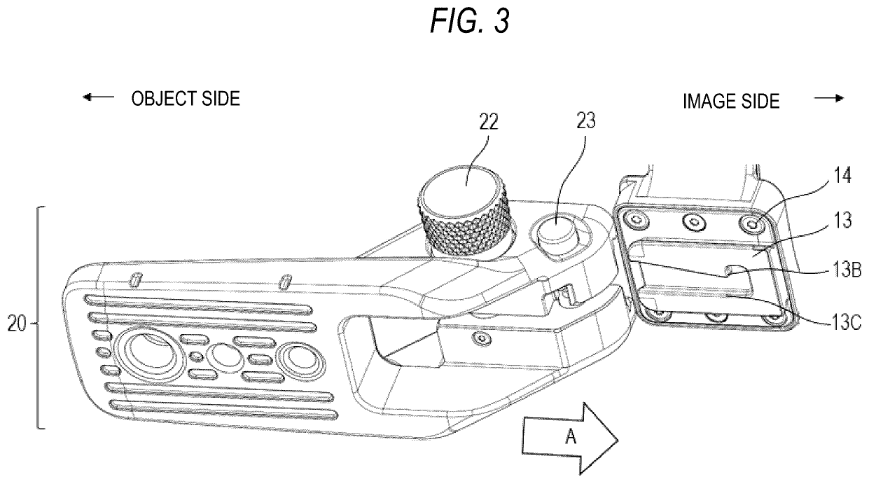

Exemplary embodiments of the present invention will now be described in detail in accordance with the accompanying drawings. First, an overall configuration of a tripod mount unit 200 attached to a lens barrel 100 (optical apparatus) according to an embodiment of the present disclosure will be described with reference to FIG. 1 to FIG. 3. FIG. 1 is a view of a lens barrel 100 in which a tripod mount 20 according to the present embodiment is mounted via a lens barrel support portion 10, as viewed from a direction (lateral direction) orthogonal to an optical axis OA. FIG. 2 is a view illustrating the tripod mount unit 200 according to the embodiment. FIG. 3 is a perspective view illustrating attachment of the tripod mount 20 to the tripod mount base 13 (base member).

The tripod mount unit 200 includes a lens barrel support portion 10 and a tripod mount 20. The lens barrel support portion 10 includes a tripod mount ring 11 (annular member), a tripod mount ring lock knob 12, and a tripod mount base 13.

The tripod mount ring 11 is supported to be rotatable around the optical axis OA with respect to a fixed component (not illustrated). The tripod mount ring lock knob 12 has a function of restricting the rotation of the tripod mount ring 11 with respect to a fixed component (not illustrated). The tripod mount ring lock knob 12 is screwed to the tripod mount ring 11. When the tripod mount ring lock knob 12 is screwed, the distal end portion of the tripod mount ring lock knob 12 abuts on a fixing member (not illustrated). An axial force due to screwing acts on a contact portion. A frictional force is generated in the contact portion by the axial force. Further, the axial force due to the screwing causes the tripod mount ring 11 to be eccentric with respect to the fixing member (not illustrated) and generates a frictional force at a radial fitting portion between the fixing member (not illustrated) and the tripod mount ring 11. The rotation of the tripod mount ring 11 can be regulated by these frictional forces. Further, the tripod mount base 13 is fixed to the tripod mount ring 11 by set screws 14. The tripod mount base 13 can be fixed to the lens barrel 100 by screwing the tripod mount ring lock knob 12. The tripod mount 20 is detachably attached to the tripod mount base 13. The tripod mount 20 is provided with a tripod mount lock knob 22 (first operation member) as operation portion and a tripod mount temporary lock release button 23 (second operation member) as operation portion. The function and movement of the operation portions will be described later.

As illustrated in FIG. 3, the tripod mount 20 can be attached to the tripod mount base 13 by sliding the tripod mount 20 in the direction of arrow A, that is, from the object side. As illustrated in FIG. 2, a dovetail groove 21A is provided in a tripod mount main body 21 (main body portion) of the tripod mount 20, and a dovetail 13A to be fitted into the dovetail groove 21A is provided in the tripod mount base 13. A lock mechanism for fixing the dovetail groove 21A to the dovetail 13A will be described later.

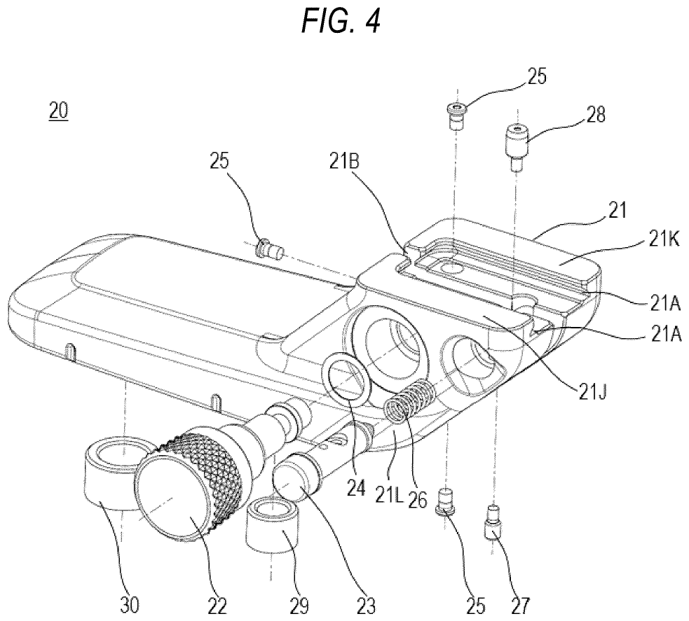

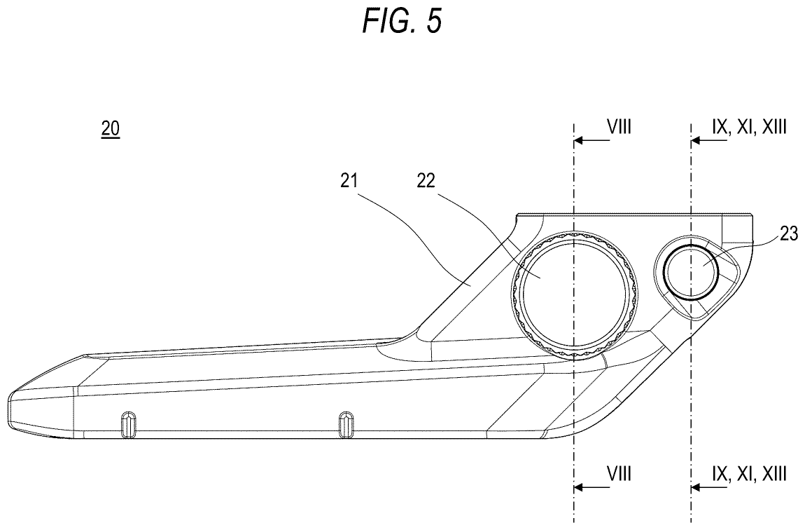

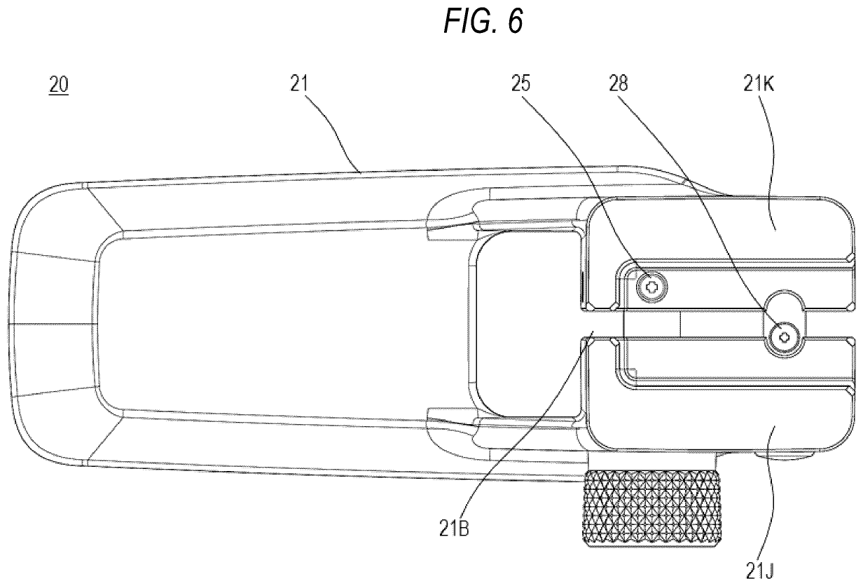

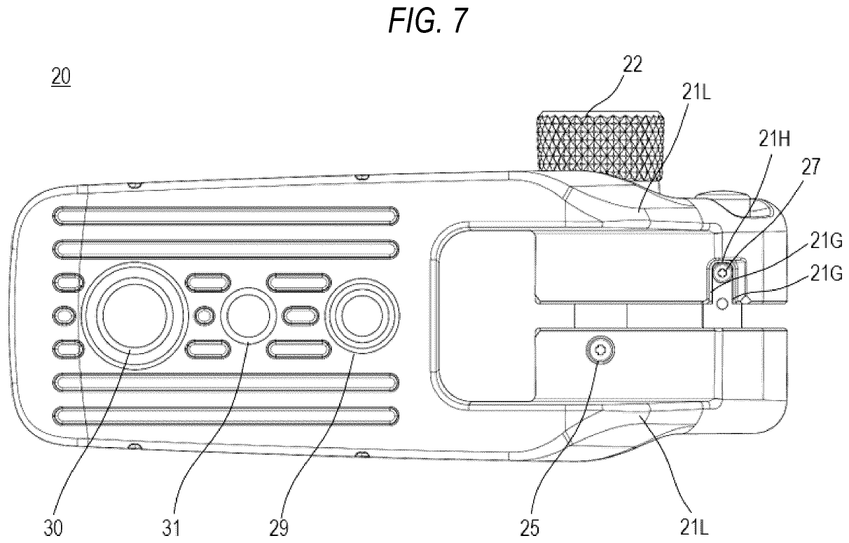

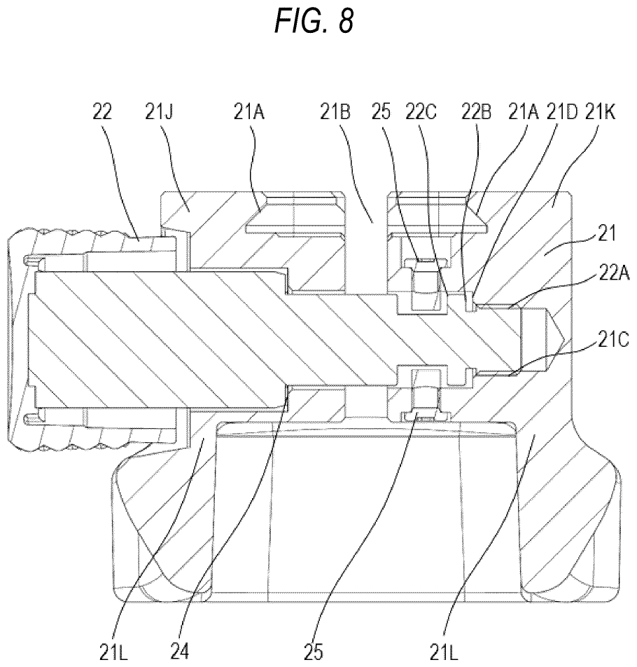

Next, a configuration of the tripod mount 20 will be described with reference to FIG. 4 to FIG. 8. FIG. 4 is an exploded perspective view of the tripod mount 20. FIG. 5 is a side view of the tripod mount 20. FIG. 6 is a plan view of the tripod mount 20. FIG. 7 is a bottom view of the tripod mount 20. FIG. 8 is a cross-sectional view taken along line VIII-VIII in FIG. 5.

As illustrated in FIG. 7, a ¼-inch camera tripod screw 29, a ⅜-inch camera tripod screw 30, and a video boss hole 31 are provided on a bottom surface of the tripod mount 20. Since the function is the same as the conventional one, the explanation of the function is omitted.

### About Lock Mechanism

Next, a lock mechanism of the tripod mount 20 will be described. The tripod mount main body 21 is provided with a slit 21B (slit portion) extending in a direction along the optical axis of the lens barrel 100. The tripod mount main body 21 is divided into two parts such as a left tripod mount main body 21J on the other side when viewed from the image plane side and a right tripod mount main body 21K on one side when viewed from the image plane side, with the slit 21B as the center. Each of the left tripod mount main body 21J and the right tripod mount main body 21K has a shape that is easily elastically deformed in a direction substantially orthogonal to (intersecting) the slit 21B with respect to a root portion 21L. The tripod mount main body 21 abuts on the tripod mount base 13.

The tripod mount lock knob 22 is disposed so as to advance and retract in a direction substantially orthogonal to (intersecting) the slit 21B of the tripod mount main body 21. The tripod mount lock knob 22 abuts on the left tripod mount main body 21J via a washer 24. The tripod mount lock knob 22 has a screw portion 22A at a distal end thereof, and the screw portion 22A is screw-coupled to a screw portion 21C provided on the right tripod mount main body 21K.

With such a configuration, when the tripod mount lock knob 22 is rotated in a tightening direction, the screw portion 22A is screwed into the right tripod mount main body 21K. Then, the width of the slit 21B is deformed with reference to the root portion 21L so that the distance between the left tripod mount main body 21J and the right tripod mount main body 21K becomes closer. Therefore, an interval of the dovetail groove 21A in the substantially orthogonal direction of the slit 21B is narrowed. In a state where the dovetail groove 21A is engaged with the dovetail 13A, when the dovetail groove 21A is narrowed by fastening the tripod mount lock knob 22, the dovetail 13A abuts on the dovetail groove 21A, and the tripod mount main body 21 can be fixed to the tripod mount base 13 by a friction force generated between these components.

Further, as illustrated in FIG. 8, a lock side mechanical end 22B and a lock release side mechanical end 22C, which are restricting portions, are provided on a tightening direction side and a loosening direction side of the tripod mount lock knob 22, respectively. In the tightening direction, the lock side mechanical end 22B abuts against the regulating portion 21D of the tripod mount main body 21 of the mating component, and the movement of the tripod mount lock knob 22 is regulated so that the tripod mount cannot be tightened any further. In the loosening direction, the lock release side mechanical end 22C abuts on the retaining screw 25 of the mating part, and the movement of the tripod mount lock knob 22 is regulated so that the tripod mount lock knob 22 cannot be loosened any more.

The reason why the lock release side mechanical end 22C is provided on the loosening direction side is to suppress the amount of deformation of the tripod mount main body 21 and to keep it within elastic deformation as a material characteristic. By keeping the amount of deformation within the range of elastic deformation, durability is improved. The material of the tripod mount main body 21 considered this time is an aluminum alloy. Although other materials may be adopted, it is necessary to set the stroke (mechanical end stroke) of the tripod mount lock knob 22 in consideration of the material characteristics as in the present embodiment. Further, another reason why the lock release side mechanical end 22C is provided on the loosening direction side is to prevent the screw coupling portion of the tripod mount lock knob 22 from being detached from the tripod mount main body 21. Further, in order to shorten the time from the completely loosened state to the tightened state, the mechanical end is set to an appropriate stroke in consideration of the quality of the parts and the like without unnecessarily increasing the stroke. The lock release side mechanical end 22C in the loosening direction is provided on the right tripod mount main body 21K where the tripod mount main body 21 and the tripod mount lock knob 22 are screwed together. Therefore, the lock release side mechanical end 22C abuts on the retaining screw 25 in the loosening direction, and even if a further loosening force is applied, the dovetail groove 21A is not widened. Therefore, there is no concern about plastic deformation of the tripod mount main body 21.

### About Temporary Lock Mechanism

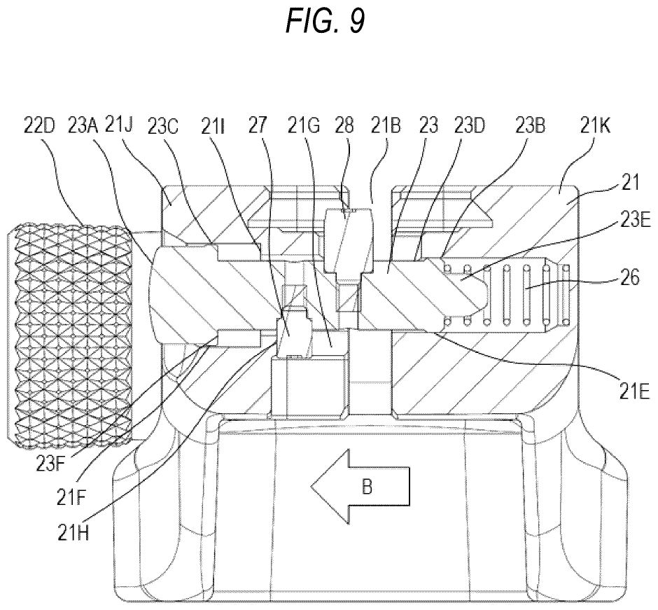

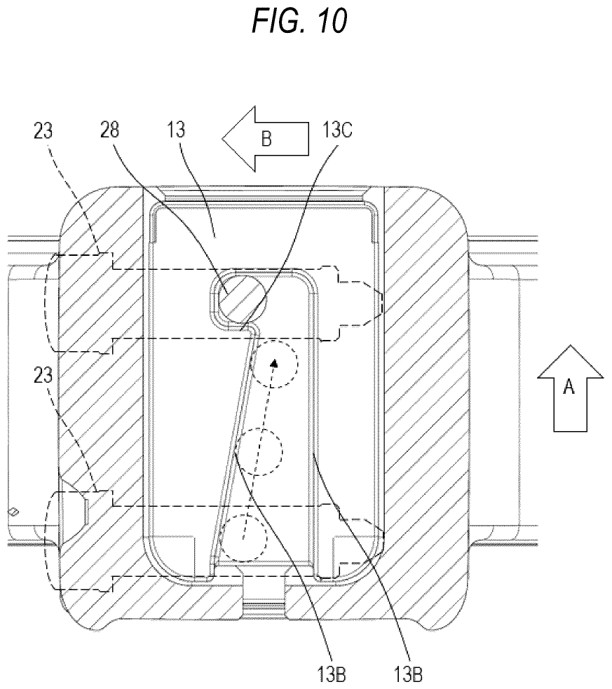

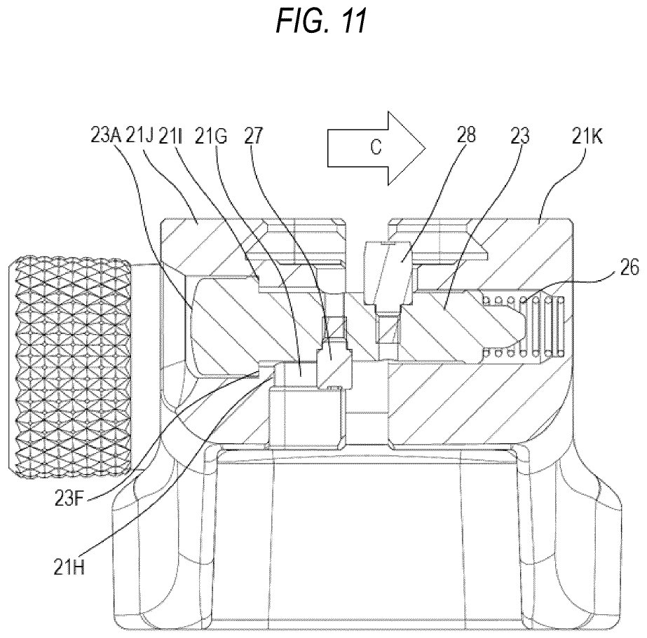

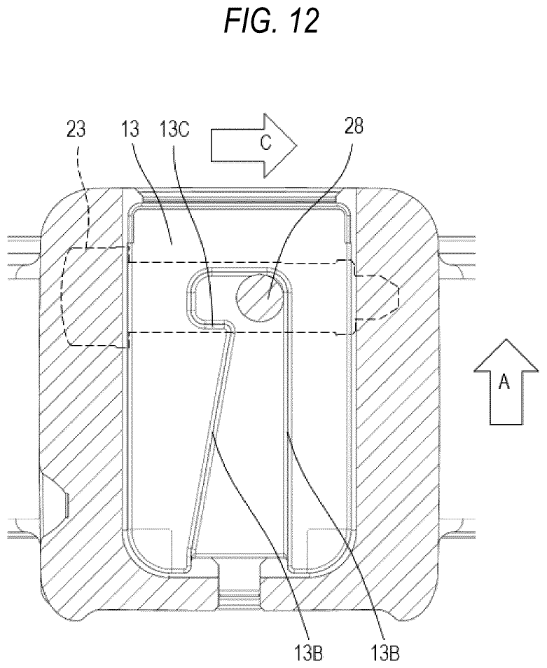

Next, a configuration of a temporary lock mechanism will be described with reference to FIG. 9 to FIG. 12. FIG. 9 is a cross-sectional view taken along line IX-IX of FIG. 5. FIG. 10 is a cross-sectional view taken along line X-X of FIG. 2. FIG. 11 is a cross-sectional view taken along line XI-XI of FIG. 5 when the temporary lock is released. FIG. 12 is a cross-sectional view taken along line XII-XII in FIG. 2 when the temporary lock is released.

First, the temporary lock mechanism will be described. As illustrated in FIG. 3, the tripod mount 20 is slid in a direction of the arrow A to be mounted on the tripod mount base 13. At that time, the movement of the tripod mount temporary lock release button 23 is as shown by the dashed line in FIG. 10. The temporary lock shaft screw 28 (projection portion) provided on the tripod mount temporary lock release button 23 is engaged with a guide groove 13B (groove portion) provided on the tripod mount base 13, and the temporary lock shaft screw 28 moves in the direction of the arrow A while being displaced in a direction opposite to a direction of the arrow B. Then, when the tripod mount 20 is slid in the direction of the arrow A to the vicinity of the end of the tripod mount base 13 so as to fit the dovetail 13A into the dovetail groove 21A, the temporary lock shaft screw 28 is guided by the guide groove 13B and moves in the direction of the arrow B and fits into the retaining groove 13C. This state is a temporary lock state in which the tripod mount base 13 and the tripod mount 20 are temporarily fixed to each other. The temporary lock mechanism is a so-called falling-off prevention mechanism and is a temporary lock shaft screw 28, the guide groove 13B and the retaining groove 13C are provided. Thus, the tripod mount temporary lock release button 23 is fitted to the tripod mount main body 21, and the tripod mount 20 is temporarily fixed so as not to fall off from the tripod mount base 13.

Next, a mechanism for releasing the temporary lock state will be described. As illustrated in FIG. 9, the tripod mount temporary lock release button 23 is disposed so as to advance and retract in a direction substantially orthogonal to the slit 21B of the tripod mount main body 21. A spring biasing force of a compression spring 26 is applied to the tripod mount temporary lock release button 23 in the direction of the arrow B substantially orthogonal to the slit 21B. The compression spring 26 is engaged with a spring engaging part 23E provided at the tip of the tripod mount temporary lock release button 23 so that a spring biasing force is always applied in the direction of the arrow B. For example, when the button portion 23A (operation portion) is pressed with a finger, the tripod mount temporary lock release button 23 moves in a direction opposite to the direction of the arrow B against the spring biasing force, and when the finger is released from the button portion 23A, the tripod mount temporary lock release button 23 moves in the direction of the arrow B by the spring biasing force.

The tripod mount temporary lock release button 23 is provided with a guide shaft screw 27, and the guide shaft screw 27 is guided by a guide groove 21G (see FIG. 7) provided in the tripod mount main body 21 in a direction substantially orthogonal to the slit 21B. Further, the guide shaft screw 27 is fitted into the guide groove 21G, whereby the rotation of the tripod mount temporary lock release button 23 is regulated. Further, a knob portion 22D (operation portion) of the tripod mount lock knob 22 and the button portion 23A of the tripod mount temporary lock release button 23 are arranged on the same side when viewed from the direction orthogonal to the slit 21B.

The tripod temporary lock release button 23 has two fitting portions. The tripod mount temporary lock release button 23 is provided with a radial fitting portion 23C (second fitting portion) fitted to the radial fitting portion 21F (second region) of the left tripod mount main body 21J and a radial fitting portion 23B (first fitting portion) fitted to the radial fitting portion 21E (first region) of the right tripod mount main body 21K. The fitting portion of the present embodiment is a diameter fitting portion that is easy to process, but this is an example, and the shape is not limited. For example, a square shaft and a square hole may be used. It is also possible to provide a plurality of shaft screws and grooves and fit them. Further, in the present embodiment, the shape of the fitting portion is a shape similar to a semi-cylindrical shape (a shape close to a semi-cylindrical shape), but this is an example, and the shape is not limited. Basically, by shortening the fitting portion of the tripod mount temporary lock release button 23 in the direction substantially orthogonal to the slit 21B, the fitting portion is less likely to be twisted when the tripod mount main body 21 described later is deformed. Furthermore, a small diameter portion 23D (recessed step) is provided on at least one of the tripod mount main body 21 and the tripod mount temporary lock release button 23 between the radial fitting portion 23B and the radial fitting portion 23C, or between the radial fitting portion 21E and the radial fitting portion 21F.

In order to restrict the movement of the tripod mount temporary lock release button 23, the following restriction portion (mechanical end) is provided on the tripod mount main body 21. As illustrated in FIG. 9, a temporary lock mechanism end 21H is formed on an end surface of the left tripod mount main body 21J on the direction of the arrow B side. The temporary lock mechanism end 21H abuts on the guide shaft screw 27, and the movement of the tripod mount temporary lock release button 23 is regulated. As illustrated in FIG. 11, a temporary lock release mechanism end 21I is formed on an end surface of the left tripod mount main body 21J on a direction of the arrow C side. A temporary lock release mechanism end 21I of the tripod mount main body 21 and a mechanism end 23F of the tripod mount temporary lock release button 23 abut on each other, and the movement of the tripod mount temporary lock release button 23 is regulated.

In order to release the temporary lock, the button portion 23A is pushed in the direction of the arrow C against the spring biasing force of the compression spring 26, the tripod mount temporary lock release button 23 is moved as illustrated in FIG. 12, and the temporary lock shaft screw 28 is removed from the retaining groove 13C. Since the temporary lock is released in this state, the tripod mount 20 can be slid in the direction opposite to the direction of the arrow A.

In conventional configurations, the lens barrel may be carried by holding the base portion without the fixing screws being tightened, furthermore, when carrying the lens barrel by holding the base portion, in order to hold it firmly, the object side and image surface side of the base of the root portion are usually held with the index finger and thumb, respectively. Then, the index finger and the thumb are caught on the knob (lock plate), and when the base portion is gripped with a sufficient force in a state where the fingers are caught on the knob, the knob is inadvertently pressed down to release the falling-off prevention mechanism, which may lead to a problem that the ring member falls off from the base portion.

However, in the configuration of the present disclosure, since the tripod mount temporary lock release button 23 is disposed so as to advance and retract in a direction substantially orthogonal to the slit 21B, when the lens barrel 100 is carried by holding the tripod mount 20, the falling-off prevention mechanism is not carelessly released. According to the present disclosure, it is possible to provide the tripod mount 20 in which the falling-off prevention mechanism is not accidentally released when the lens barrel 100 is carried with the tripod mount 20.

### About Shapes That Avoid Interference Problems Due to Elastic Deformation

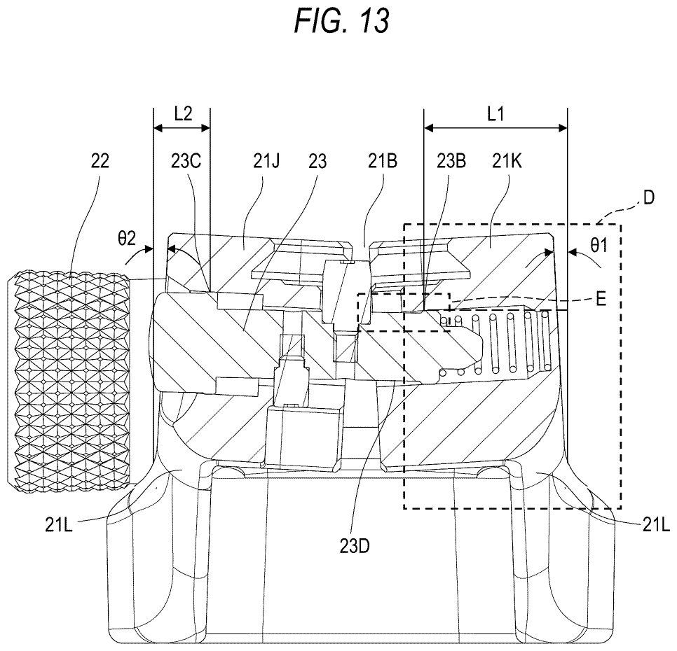

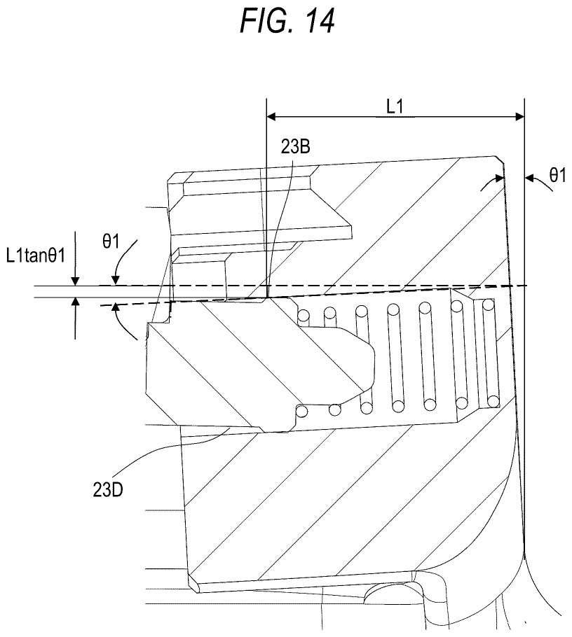

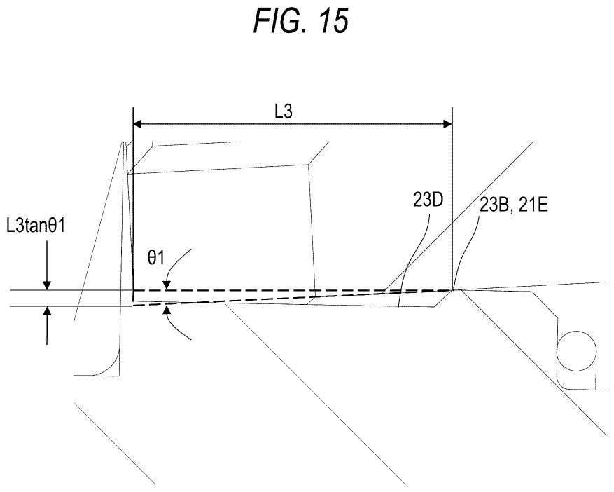

Next, with reference to FIG. 13 to FIG. 15, a description will be given of a configuration for avoiding an interfering problem that may occur due to elastic deformation of the root portion 21L of the tripod mount main body 21. FIG. 13 is a cross-sectional view taken along line XIII-XIII of FIG. 5, in which the deformation by the tripod mount lock knob 22 is exaggerated. FIG. 14 is an enlarged view of a range D in FIG. 13. FIG. 15 is an enlarged view of a range E in FIG. 13.

As illustrated in FIG. 8, in the state of the tripod mount 20 alone, the tripod mount lock knob 22 is screwed, and the tripod mount lock knob 22 is tightened until the lock side mechanical end 22B abuts on the regulating portion 21D of the tripod mount main body 21. Then, as illustrated in FIG. 13, the tripod mount main body 21 is elastically deformed (deformed in a so-called V-shape) so that the distance of the slit 21B is narrowed with reference to the root portion 21L of the tripod mount main body 21, and the left tripod mount main body 21J and the right tripod mount main body 21K are deformed so as to approach each other. In this embodiment, FIG. 13 is a cross-sectional view in which the amount of deformation is exaggerated for easy understanding. A position of the fitting portion between the tripod mount main body 21 and the tripod mount temporary lock release button 23 is also changed by the deformation in which the right tripod mount main body 21K approaches. For example, inclination amount θ1 of right tripod mount main body 21K, when a length from the root portion 21L to the fitting portion (radial fitting portion 23B) is defined as a length L1, the position of the fitting portion is changed by a length of the L1tanθ1. The left tripod mount main body 21J is formed in the same manner, inclination amount θ2 of left tripod mount main body 21J, when a length from the root portion 21L to the fitting portion (radial fitting portion 23C) is defined as a length L2, the position of the fitting portion is changed by a length of the L2tanθ2. If the length of the L1tanθ1 and the length of the L2tanθ2 are different, the amount of position change will differ, so the tripod mount temporary lock release button 23 of the counterpart component will fit at an oblique position. In this state, the gap between the tripod mount main body 21 and the tripod mount temporary lock release button 23 will narrow in the area away from the fitting portion due to the change in shape caused by the deformation above described. As illustrated in FIG. 15, if the dimension from the fitting portion to the slit 21B is defined as a length L3, the gap narrows by the length of the L3tanθ1. Therefore, it is necessary to consider an amount by which the gap narrows due to for deformation to be accommodated.

In the present embodiment, the small diameter portion 23D which is one step lower than the radial fitting portion 23B of the tripod mount temporary lock release button 23 is provided to release the deformation. However, the shape is not limited to that of the present embodiment. For example, the shape of the tripod mount main body 21 of the mating component may be raised to have a larger diameter. Further, there is also a method of setting the fitting setting between the radial fitting portion 21E and the radial fitting portion 23B such that the fitting backlash amount is larger than the gap narrowing amount without separately providing the stepped shape.

In this way, the tripod mount temporary lock release button 23 can be arranged in a direction substantially orthogonal to the slit 21B without interference between components by forming the tripod mount temporary lock release button 23 into a shape in consideration of the amount of narrowing of the interval due to deformation. With this arrangement, when the tripod mount main body 21 is carried by hand in a state where the tripod mount 20 is attached to the lens barrel 100, the risk of inadvertently pressing the tripod mount temporary lock release button 23 can be reduced as much as possible.

Further, in the present embodiment, since the tripod mount temporary lock release button 23 and the tripod mount lock knob 22 can be arranged adjacent to each other, the operation of attachment and detachment is easy. For example, there is a scene in which a camera (not illustrated), the lens barrel 100, and the tripod mount 20 are mounted, photographing is performed in a state where the tripod is screw-fixed to the tripod mount 20, and the tripod mount 20 is desired to be removed from the lens barrel 100 by suddenly changing a subject. At this time, it is possible to quickly remove the tripod mount 20 only with the left hand while holding the camera grip and the shutter button with the right hand. Therefore, the possibility of missing a photo opportunity is reduced.

Although the preferred embodiments of the present disclosure have been described above, the present disclosure is not limited to these embodiments, and various modifications and changes can be made within the scope of the gist of the present disclosure.

While the embodiments of the present invention have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-183630, filed Oct. 26, 2023, which is hereby incorporated by reference herein in its entirety.

What is claimed is:

1. A tripod mount attachable to and detachable from a base member fixable to an optical apparatus, the tripod mount comprising:
a main body portion that abuts on the base member and has a slit portion,
a first operation member screwed to the main body portion and capable of fixing the tripod mount to the base member by deforming the main body portion so as to change a width of the slit portion, and
a second operation member fitted to the main body portion and capable of temporarily fixing the tripod mount to the base member,
wherein the first operation member and the second operation member are disposed so as to advance and retract in a direction intersecting the slit portion.

2. The tripod mount according to claim 1, wherein the slit portion extends in a direction along an optical axis of the optical apparatus.

3. The tripod mount according to claim 1, wherein the main body portion is provided with a dovetail groove, the base member is provided with a dovetail to be fitted into the dovetail groove, and
wherein the tripod mount is fixed to the base member by fastening the first operation member in a state where the dovetail is fitted into the dovetail groove.

4. The tripod mount according to claim 3, wherein the base member is provided with a groove portion,
wherein the second operation member includes a projection portion that engages with the groove portion,
wherein when the main body is slid with respect to the base member so as to fit the dovetail into the dovetail groove, the projection portion is guided by the groove portion, and
wherein the base member and the tripod mount are temporarily fixed to each other by fitting the projection portion into a retaining groove provided in the groove portion.

5. The tripod mount according to claim 1, wherein the second operation member includes a first fitting portion and a second fitting portion which are fitted to the main body portion,
wherein the main body portion includes a first region provided on one side of the main body portion divided into two by the slit portion and fitted to the first fitting portion, and a second region provided on the other side of the main body portion divided into two by the slit portion and fitted to the second fitting portion, and
wherein at least one of the main body portion between the first fitting portion and the second fitting portion or between the first region and the second region and the second operation member is provided with a concave step.

6. The tripod mount according to claim 1, wherein each operation portion of the first operation member and the second operation member is disposed on the same side when viewed from a direction intersecting the slit portion.

7. A tripod mount unit having a tripod mount, the tripod mount comprising:
a base member attachable to and detachable from the tripod mount,
a main body portion that abuts on the base member and has a slit portion,
a first operation member screwed to the main body portion and capable of fixing the tripod mount to the base member by deforming the main body portion so as to change a width of the slit portion,
a second operation member fitted to the main body portion and capable of temporarily fixing the tripod mount to the base member, and
an annular member coupled to the base member,
wherein the first operation member and the second operation member are disposed so as to advance and retract in a direction intersecting the slit portion, and
wherein the tripod mount is attachable to and detachable from the base member which can be fixed to an optical apparatus.

8. An optical apparatus having a tripod mount unit attached thereto, the tripod mount unit having a tripod mount, the tripod mount comprising:
a base member attachable to and detachable from the tripod mount,
a main body portion that abuts on the base member and has a slit portion,
a first operation member screwed to the main body portion and capable of fixing the tripod mount to the base member by deforming the main body portion so as to change a width of the slit portion,
a second operation member fitted to the main body portion and capable of temporarily fixing the tripod mount to the base member, and
an annular member coupled to the base member,
wherein the first operation member and the second operation member are arranged so as to advance and retract in a direction intersecting the slit portion, and
wherein the tripod mount is attachable to and detachable from the base member which can be fixed to the optical apparatus.
